(19) United States
(12) Patent Application Publication
(10) Pub. No.: US 2012/0301608 A1
(43) Pub. Date: Nov. 29, 2012

(54) MOULD FOR LITHOGRAPHY BY NANO-IMPRINTING AND MANUFACTURING METHODS

(75) Inventor: Stefan Landis, Voiron (FR)

(73) Assignee: Commissariat a l'energie atomique et aux energies alternatives, Paris (FR)

(21) Appl. No.: 13/574,371

(22) PCT Filed: Jan. 27, 2011
(86) PCT No.: PCT/EP2011/051137

§ 371 Date: Jul. 20, 2012

(30) Foreign Application Priority Data
Jan. 28, 2010 (FR) 1050569

(51) Int. Cl. B29C 59/02; B82Y 40/00

(52) U.S. Cl. 427/133; 425/385; 977/902

(57) ABSTRACT

The invention concerns a mould for lithography by nano-imprinting, together with its manufacturing methods. This mould has a face which includes n structured zone(s) with patterns of micrometric or nanometric size, where n is an integer greater than or equal to 1. This structured face belongs to a first layer which is supported by a second layer, where the first layer is made of a rigid material and the second layer is made of a flexible material.

This mould may also include n intervening layers positioned between the first layer and the second layer, where n is an integer greater than or equal to 1, and in which the Young's modulus of the second layer is lower than the Young's modulus of the n^{th} intervening layer adjacent to the second layer, and if n is greater than 1, the Young's modulus of the (i)^{th} intervening layer is greater than the Young's modulus of the (i+1)^{th} intervening layer, with i=1 to (n−1).

### TECHNICAL FIELD

The invention concerns a mould for lithography by nano-imprinting, together with the methods for manufacturing such a mould.

### STATE OF THE PRIOR ART

There are two types of lithography by nano-imprinting:
nano-imprinting assisted by wavelength;
thermal nano-imprinting.

Lithography by nano-imprinting consists, in the case of thermal nano-imprinting, in duplicating patterns by hot pressing a mould in a polymer film positioned on a substrate for imprinting or, in the case of nano-imprinting assisted by wavelength, in duplicating patterns by pressing a mould, which is transparent to the mould's operating wavelength, in a photosensitive polymer film positioned on a substrate, and application of radiation of an operating wavelength (for example, a UV radiation) through the mould. The patterns reproduced in the polymer film are then etched in the substrate for imprinting underlying the polymer film.

It is stipulated that nano-imprinting designates the imprinting of patterns the size of which (length, width and/or diameter) is between a few nanometres and several hundred micrometres.

Typically, the mould used to shape the polymer film is a rigid mould.

The rigid mould is usually produced in a substrate made of a material which is easily structured, for example silicon, and is obtained by standard lithography and etching techniques. By this means it is possible to obtain moulds with large areas (several hundred cm²).

However, it is sometimes necessary to use material which is difficult to structure, such as silica or quartz, for example when it is desired to obtain a mould which is transparent to UV radiation. In this case manufacture of the mould by lithography and etching becomes increasingly problematic the greater the resolution (resolutions of less than or equal to a few tens of nanometres).

In addition, use of a rigid mould makes the imprinting of patterns with satisfactory uniformity very difficult or impossible: the more rigid the mould the more it becomes difficult to obtain uniform contact (or conformal contact) at all points between a rigid mould and the substrate to be etched. Indeed, as the surfaces to be brought into contact are never perfectly flat, it is necessary, in order for there to have contact across the entire surface between the mould and the substrate to be imprinted, either that the mould is able to be deformed, which is possible only if the mould is not too rigid, or to reduce the area of the mould to increase its flatness. As a consequence, the maximum area which it is possible to imprint in a single step using a rigid quartz mould during lithography by nano-imprinting assisted by UV radiation is typically of a few cm², whereas it is possible to imprint several hundred cm² by using a silicon mould during lithography by thermal nano-imprinting.

Thus, in order firstly to prevent contact which might be destructive between the rigid mould and the substrate to be imprinted, and secondly to homogenise the pressing of the mould on the polymer film, it is known to keep a residual fine layer of polymer at the bottom of the patterns duplicated in the polymer film. The residual thickness is subsequently eliminated by an oxygen plasma and the patterns of the mould are transferred into the underlying substrate by etching.

The disadvantage of this solution is that it requires that a uniform residual thickness is obtained in order to achieve a transfer of the patterns whilst retaining the lateral dimensions of the patterns. And, when the patterns are imprinted, the appearance of a local uniformity of the residual thickness near the edges of the mould is observed, which is caused by changing from a zone which is dense with patterns to a zone without patterns. In order to minimise the number of these local uniformities it is therefore preferable to use a mould with a large area rather than several small moulds. However, we have just demonstrated that the maximum area of a mould was limited by its rigidity.

In addition, it is known to use a flexible mould (i.e. one with a low Young's modulus) made of PolyDiMethylSiloxane (PDMS). The elasticity of a mould made of PDMS enables conformal contact to be obtained between the mould and the substrate to be imprinted. However, the resolution of such a mould is limited to 0.5 micrometre due to the problems of mechanical stability of the mould during pressing: small-sized patterns (typically less than 500 nm) do not have sufficient mechanical stability to resist during the pressing, which causes several types of mechanical deformation of the mould, limiting thereby the mould's potential resolution. A mould made of PDMS cannot therefore be used to produce structures having resolutions of several nanometres, or even several tens of nanometres.

It has been envisaged to modify the chemical formulation of the PDMS in order to improve its mechanical properties (see document [1] referenced at the end of the description). An investigation of the collapse of a mould made of PDMS as a function of the PDMS' polymerisation time enables it to be supposed that imprinting of finer patterns is possible with a mould having a greater elastic modulus and greater surface hardness. However, too great a rigidity or elastic modulus can make the material brittle and limit its capacity to generate conformal contact with the substrate to be imprinted. In addition, the use of PDMS by thermal crosslinking remains an intrinsic limit for the manufacture of moulds having very high resolution. Indeed, the cooling cycle of PDMS can cause mechanical stresses in the material, and consequently limit its resolution. It follows that, if it is desired to obtain patterns of a size smaller than 100 nm moulds made of rigid material must be used.

In light of the problems posed by the moulds of the prior art, the inventor has set himself the aim of designing a mould for lithography by nano-imprinting which enables the faults created during the imprinting step to be minimised, and in particular the residual thickness distribution to be minimised, enabling a conformal contact to be obtained between the mould and the substrate to be imprinted, where the mould can have patterns the size of which is between a few nanometres and several micrometres, whether the mould is suitable for lithography by thermal nano-imprinting, or lithography assisted by wavelength (for example UV wavelength).

### DESCRIPTION OF THE INVENTION

This aim is achieved by means of a mould for lithography by nano-imprinting having a first structured face including n structured zone(s) with patterns of micrometric or nanometric size, where n is an integer greater than or equal to 1, characterised in that the said first structured face belongs to a first layer which is supported by a second layer, and where the first layer is made of a rigid material and the second layer is made of a flexible material.

In the foregoing and in what follows the expression “structured with patterns of micrometric on nanometric size”, applied to a face or a layer, means that the face or the layer in question includes patterns, at least one dimension of which, of its length, its width and its diameter, is less than 1 mm and greater than 1 μm, in the case of patterns of micrometric size, and is greater than or equal to 1 nanometre and less than 1000 nanometres in the case of patterns of nanometric size.

In the context of the invention the patterns can be raised patterns or grooved (recessed) patterns. They can be dispersed uniformly in the n zones, and are preferably equidistant within a given zone. The patterns are advantageously identical (they have the same dimensions and the same shape). The n structured zones are advantageously identical.

In the foregoing and in what follows the term “rigid”, applied to a layer, means that this layer has a bending strain (deflection) of less than a limiting value determined when a determined pressure is applied to the surface of this layer.

Similarly, in the foregoing and in what follows the term “flexible”, applied to a layer, means that this layer has bending strain greater than or equal to a limiting value determined when a determined pressure is applied to the surface of this layer.

To determine the limiting value several simple calculations must be made. For example, let us take the case of a mould made of silicon and quartz, having the following characteristics:

E_{Si}=130 GPa ν_{SiO2}=0.16

v_{Si}=0.28 h_{Sio2}=6 mm

h_{Si}=750 μm

E_{SiO2}=71.7 GPa

where E is the Young's modulus, ν is the Poisson coefficient and h is the height of the layer concerned.

The flexural rigidity of an object is given by the following formula:

$$D = \frac{E \times {h}^{3}}{12 \times ( 1 - {v}^{2} )}$$

In the case of a square plate of sides a, having thickness h, the maximum generated deflection (during bending) w is approximately equal to:

$$w \approx \frac{P \times {a}^{4}}{D}$$

Therefore, if in the example above the pressure applied uniformly to the mould is equal to 2.10⁵ Pa and the side a of the plates has a value of 20.10⁻³ m, this then gives:

w_{Si}≈500 μm

w_{SiO2}≈25 μm

By means of these calculations the deflection of each layer considered individually has been obtained.

To obtain the limiting value enabling it to be considered that a layer is flexible or rigid, a comparison must be made between the value of the calculated deflection and the value of the surface roughness (or topography) of the substrate which it is desired to imprint using the mould. Indeed, when an imprint is made there must be close contact (also called “conformal” contact) between the mould and the substrate to be imprinted; the entire surface of the mould must therefore be in direct contact with the entire surface of the substrate to be imprinted.

For example, a substrate consisting of a plate of silicon measuring 200 mm in diameter has a roughness of 50 μm (data item provided by the supplier of the silicon plate). Therefore, if the layer of the mould has a deflection greater than or equal to the roughness value of the substrate to be imprinted given by the manufacturer, namely 50 μm, this layer will be considered to be a flexible material compared to the substrate which it is desired to imprint. Conversely, if the value of the deflection of the layer of the mould is less than the roughness value of the substrate to be imprinted, the layer will be considered to be a rigid material.

Thus, in our example, the layer of silicon (w_{Si}≈500 μm) is considered to be flexible, whereas the layer of quartz (w_{SiO2}≈25 μm) is considered to be rigid.

Advantageously, the mould further comprises p intervening layers between the first layer and the second layer, where p is an integer greater than or equal to 1, and in which the Young's modulus of the second layer is lower than the Young's modulus of the p^{th} intervening layer adjacent to the second layer, and if p is greater than 1, the Young's modulus of the (i)^{th} intervening layer is greater than the Young's modulus of the (i+1)^{th} intervening layer, with i=1 to (p−1). The Young's modulus of the first layer is preferably greater than or equal to the Young's modulus of the 1^{st} intervening layer. There is thus a Young's modulus gradient, which enables the sudden transitions between the rigid layer and the flexible layer to be prevented, and which enables the structure to be prevented from breaking. This also enables the thickness of the first rigid layer to be reduced. This allows improved distribution over the structured face of the force applied to the opposite face of the mould.

It should be noted that the layers included in the mould are of a thickness of between several hundred micrometres and a few millimetres.

Advantageously, the second layer of the mould is itself supported by a support made of a rigid material. The support can be a substrate or a layer made of rigid material. Adding this support enables the mould to be strengthened, and its brittleness to be reduced. Indeed, it enables a pressing force to be applied to the rigid support during handling without damaging the second layer. According to a variant, the support made of rigid material is a cylindrically-shaped element, where the layer is supported by the cylindrical portion of the support. The use of a cylindrically-shaped element as a support enables, for example, a roller print to be produced.

Advantageously, the mould also has a second structured face including m structured zone(s) with patterns of micrometric or nanometric size, where m is an integer greater than or equal to 1, where the said second face belongs to a third layer, which is made of a rigid material, and where the first and second structured faces are positioned either side of the second layer made of flexible material. This particular arrangement has the advantage that it allows the imprinting speed to be doubled when such a mould is used.

Advantageously, at least one face of the first structured face and the second structured face includes a single structured zone (i.e. n=1 and/or m=1), where the said structured zone occupies the entire surface of the said at least one face. In other words, structuring is not confined to certain locations of the face, but extends across the entire face.

According to a particular variant the mould may also include an intervening layer between the first layer and the second layer, where the said intervening layer is made of a rigid material, and where the face of the intervening layer which is opposite the first layer is structured with n cavities positioned opposite the n structured zones of the first layer, and is covered by the second layer such that the n cavities are filled by a flexible material. It is perfectly possible that this intervening layer and the first layer are made of an identical material; this then amounts to having, instead of a first layer and an intervening layer, a single layer (the first layer), where this single layer has on one face the n structured zones, and on its opposite face n cavities opposite the n structured zones.

Generally, the mould according to the invention can be used for any technology for shaping a material requiring a mould, and in particular for imprinting by microcontact.

The mould can also be adapted to a particular use, such as nano-imprinting assisted by a particular wavelength or a thermal nano-imprinting, depending on the materials constituting the mould.

All the layers constituting the mould, together with the support, if present, can thus advantageously be made of materials which are transparent to a wavelength λ which is within the range of UV wavelengths, i.e. at a wavelength of between 193 nm and 400 nm, or from materials which are transparent to a wavelength λ within the range of wavelengths of visible light, i.e. at a wavelength of between 400 nm and 800 nm. A mould is then obtained which can be used to implement nano-imprinting assisted by UV, or nano-imprinting assisted by visible light, respectively.

According to a variant, the support can be made of quartz or silica, the first layer of silica and the second layer of polydimethylsiloxane (PDMS) or silicone.

Advantageously, all the layers constituting the mould, together with the support, if present, are made of thermally conductive materials, i.e. materials having a thermal conductivity greater than several tens of W·m⁻¹·K⁻¹. This then produces a mould which can be used for thermal imprinting.

It is perfectly possible that one or more of the layers constituting the mould, and possibly the support, may be made of a material which is both transparent to a wavelength λ and thermally conductive.

Moreover, the invention concerns a first method of manufacture of a mould for lithography by nano-imprinting including a structured face having n structured zones with patterns of micrometric or nanometric size, where the method includes the following steps:

a) supply of an initial substrate;

b) structuring of a face of the said initial substrate, called the front face, according to a pattern representing the negative imprint of the n structured zones which it is desired to obtain on the structured face of the mould;

c) deposition of a first layer on the front face of the initial substrate so as to cover the relief formed in structuring step b), where the first layer and the initial substrate are made of different materials and the first layer is made of a rigid material;

d) deposition of a second layer on the first layer, where the second layer is made of a flexible material;

e) removal of the initial substrate.

The production of a “negative imprint” is understood to mean the production of a relief which fits perfectly the relief which it is desired to obtain, namely the n structured zones of the front face of the mould.

Advantageously, the first manufacturing method further comprises, between step c) and step d), a step c′) of structuring of the first layer so as to obtain n cavities opposite the n structured zones present on the opposite face of the first layer.

Advantageously, the first manufacturing method further comprises, between step c) and step d), or between step c′) and step d), a step of deposition of p intervening layers on the first layer, where p is an integer greater than or equal to 1, and in which the Young's modulus of the p^{th} intervening layer, intended to be adjacent to the second layer which will be deposited in step d), is greater than the Young's modulus of the said second layer, and if p is greater than 1, the Young's modulus of the (i)^{th} intervening layer is greater than the Young's modulus of the (i+1)^{th} intervening layer, with i=1 to (p−1). The Young's modulus of the first layer is preferably greater than or equal to the Young's modulus of the 1^{st} intervening layer. A gradient of flexibility is thus obtained between the first layer and the second layer.

Advantageously, step b) of the method includes the following steps:
deposition of a layer of photosensitive resin on a face of the initial substrate;
exposure of the layer of photosensitive resin according to the pattern representing the negative imprint of the n structured zones which it is desired to obtain on the structured face of the mould;
etching of the exposed resin layer;
etching of the face of the initial substrate not covered by the resin layer.

According to a first variant, step e) of the method is obtained by selected etching of the initial substrate. In this case, the material of the first layer and the material of the initial substrate are chosen such that it is possible to etch the initial substrate selectively without etching the first layer. The selective etching may, for example, be a wet etching.

According to a second variant, step e) of the method includes machining of the rear face of the initial substrate, followed by selective etching of the initial substrate.

The said first method of manufacture also advantageously includes, after step d) and before or after step e), a step of deposition of a support made of rigid material on the second layer. Deposition of the support can thus be accomplished before or after removal of the initial substrate.

The invention also concerns a second method of manufacture of a mould for lithography by nano-imprinting including a structured face having n structured zones with patterns of micrometric or nanometric size, where the method includes the following steps:

j) supply of a substrate made of rigid material;

k) structuring of a face of the substrate, called the front face, so as to obtain the n structured zones;

l) thinning of the substrate by etching of the rear face of the said substrate;

m) deposition of a layer of flexible material on the rear face of the substrate.

According to a variant, step l) is replaced by a step l′) of structuring of the rear face of the substrate so as to obtain n cavities positioned opposite the n structured zones of the front face.

Advantageously, the substrate is a stack of layers including, in order, a layer of first material, a layer of second material and a layer of third material, where the first and third materials are rigid materials, and in which the layer of second material acts as a stop layer for the structuring undertaken in step k) and/or for the structuring undertaken in step l′). For example, the structuring in step l′) can continue until the layer of second material is reached. If the structuring is obtained by etching, the layer of second material may be made of a material capable of stopping the etching. The stack may, for example, be an SOI substrate.

Advantageously, the said second manufacturing method also includes, between step l) and step m), or between step l′) and step m), a step of deposition of p intervening layers on the rear layer of the substrate, where p is an integer greater than or equal to 1, and in which the Young's modulus of the p^{th} intervening layer, intended to be adjacent to the layer of flexible material which will be deposited in step m), is greater than the Young's modulus of the said layer of flexible material which will be deposited in step m), and if p is greater than 1, the Young's modulus of the (i)^{th} intervening layer is greater than the Young's modulus of the (i+1)^{th} intervening layer, with i=1 to (p−1).

The said second manufacturing method also advantageously includes, after step m), a step of deposition of a support made of rigid material on the layer of flexible material deposited in step m).

Advantageously, step k) includes the following steps:
deposition of a layer of photosensitive resin on the front face of the substrate;
exposure of the layer of photosensitive resin according to the pattern representing the positive imprint of the n structured zones which it is desired to obtain on the front face of the mould;
etching of the exposed resin layer;
etching of the front face of the substrate not covered by the resin layer.

“Positive imprint” is taken to mean the imprinting of a relief identical to the relief which it is sought to obtain.

Advantageously, step l′) includes the following steps:
deposition of a layer of photosensitive resin on the rear face of the substrate;
exposure of the layer of photosensitive resin according to the pattern representing the positive imprint of the n cavities which it is desired to obtain on the rear face of the mould;
etching of the exposed resin layer;
etching of the rear face of the substrate not covered by the resin layer.

In the first and second methods according to the invention, all the layers constituting the said mould, together with the support made of rigid material, if present, are advantageously made of materials transparent to a wavelength λ in the range of UV wavelengths, in the range of wavelengths of visible light, and/or are made of thermally conductive materials.

Both methods according to the invention enable moulds to be obtained having at the surface patterns of micrometric or nanometric size, whilst using simple lithography and etching methods, which are well known and understood by the skilled man in the art. In particular, the methods of manufacture of a mould according to the invention are compatible with the methods habitually used in microelectronics and in the field of microtechnologies.

Furthermore, although it was necessary in the prior art to etch substrates several hundreds of micrometres thick, sometimes in very rigid materials of the silica or quartz type, which are very difficult to etch, in particular to obtain patterns of less than 100 nm in size, it is now possible to structure the mould in a layer of easily structured material, such as, for example, a layer of silicon, without being restricted by the fact that the material must be transparent or opaque. It is thus possible to structure a layer of silicon to manufacture a mould for nano-imprinting assisted by W. Manufacture of the moulds is thus substantially simplified, and the production costs are by the same token reduced.

It is recalled that a material is said to be opaque when it does not let light through it, or lets only a little light through it. It will in fact be considered that a material having a thickness X is opaque when its transmittance is less than or equal to 0.2. Similarly, a material is said to be transparent when it allows light to pass through it; it will be considered that a material having a thickness X is transparent when its transmittance is greater than or equal to 0.85. Secondly, it is recalled that the transmittance of a material is the ratio of the energy transmitted through this material to the incident energy. For a given substance, with a defined thickness and a defined wavelength, transmittance is a constant.

The mould according to the invention also enables a conformal contact to be obtained between the mould and the substrate to be imprinted when they are brought into contact through the presence of at least one layer of flexible material, which enables the pressure applied to be mould during the imprint to be made uniform. The mould according to the invention therefore has both mechanical rigidity sufficient to make imprints of patterns of a few nanometres, whilst having a certain flexibility (adjusted according to the flexible layer(s) used). It is thus possible to resolve simultaneously the problem relating to the resolution of the patterns and the problem relating to pressing uniformity during imprinting.

### BRIEF DESCRIPTION OF THE FIGURES

The invention will be better understood and other advantages and features will appear on reading the following description, which is given as a non-restrictive example, accompanied by the appended illustrations, among which:

FIG. 1 represents an example of a mould according to the invention,

FIG. 2 represents another example of a mould according to the invention,

FIG. 3 represents yet another example of a mould according to the invention,

FIG. 4 represents another example of a mould according to the invention,

FIG. 5 represents another example of a mould according to the invention,

FIGS. 6a to 6h represent the steps of a method of manufacture of a mould according to the invention,

FIGS. 7a to 7g represent the steps of another method of manufacture of a mould according to the invention.

### DETAILED ACCOUNT OF PARTICULAR EMBODIMENTS

The mould according to the invention includes on at least one of its faces patterns in two or three dimensions of micrometric or nanometric size, made in a layer made of a rigid material supported by at least one layer made of flexible material. This combination of a rigid layer and at least one flexible layer enables, firstly, patterns of nanometric size to be reproduced, and secondly conformal contact to be obtained between the mould and the substrate to be imprinted when they are brought into contact.

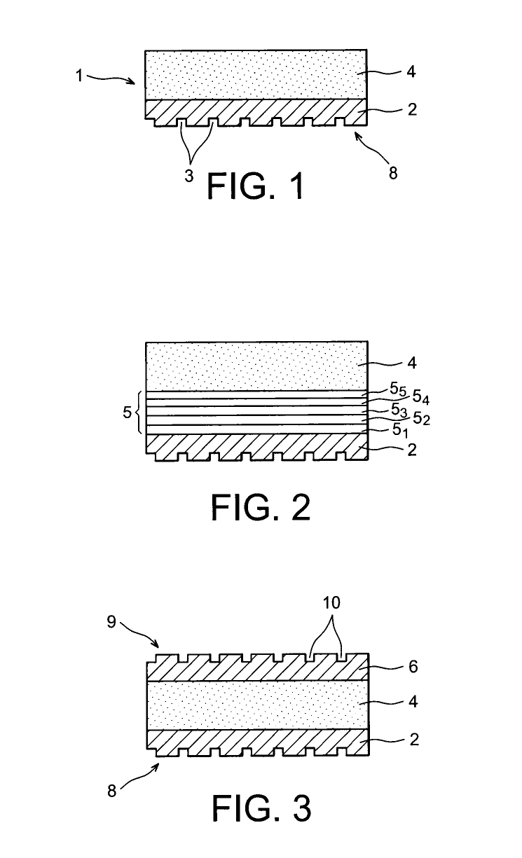

Mould 1 according to the invention may consist of a single layer of rigid material 2 including patterns 3 of micrometric or nanometric size, and a layer of flexible material 4, supporting the layer of rigid material, as represented in FIG. 1.

The mould according to the invention can also include several layers of flexible material. For example, in FIG. 2, five layers of flexible material, called intervening layers 5₁, 5₂, 5₃, 5₄, 5₅, are positioned between layer of rigid material 2 forming the front face of mould 1 and layer of flexible material 4 forming the rear face of the mould. The intervening layers are chosen so as to adjust gradually the mechanical properties between the layer of rigid material of the front face and the layer of flexible material of the rear face of the mould: there is then a gradient of mechanical properties between the layer of rigid material of the front face and the layer of flexible material of the rear face of the mould. The intervening layers are therefore positioned in increasing order of Young's modulus, where the intervening layer having the highest Young's modulus 5₅ is positioned adjacent to layer of flexible material 4 of the rear face of the mould, and having a Young's modulus lower than the modulus of the said layer of flexible material.

The mould according to the invention can also include two faces having patterns of micrometric or nanometric size. As illustrated in FIG. 3, mould 1 can include two layers of rigid material 2 and 6 structured with patterns 3 of micrometric or nanometric size, and positioned either side of a layer of flexible material 4.

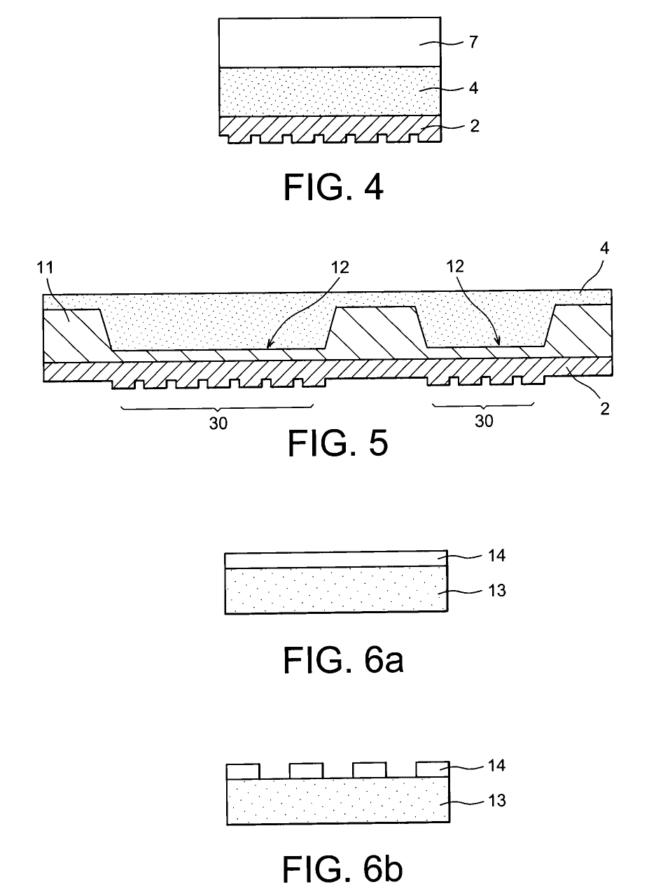

Mould 1 according to the invention may possibly also include a support 7 made of rigid material, positioned on flexible layer 4 (FIG. 4) to consolidate the mould and to make it less brittle, or again to adapt the mould for specific applications, such as for example “roller imprint” applications, by transferring the mould's flexible layer onto a cylindrically-shaped support.

In FIGS. 1, 2, 4 above, the entire area of the first layer of rigid material is structured. But it is also possible that only one or several zone(s) of the surface of the layer are structured. For example, FIG. 5 represents a mould including a rigid layer 2 having several zones including patterns. The representation of the mould according to a section view enables it to be deduced that this mould has at least two zones 30 having patterns 3. The mould represented in FIG. 5 also includes, between layer of rigid material 2 and layer of flexible material 4, an intervening layer 11 of rigid material of which the face opposite layer of rigid material 2 has cavities positioned opposite the zones with patterns of layer of rigid material 2. Here, according to the section representation, it can be seen that intervening layer 11 includes two cavities positioned opposite two structured zones. Layer of flexible material 4 covers intervening layer 11, completely filling the cavities (the relief of the intervening layer is completely covered). The intervening layer and layer of rigid material 2 may be made of the same material. The fact that the intervening layer has different thicknesses enables the mechanical properties of the mould above the structured zones to be adjusted simply.

The materials of the layers forming the mould are chosen according to their Young's coefficient, preferably according to the ease with which they can be structured by steps of lithography and etching, and possibly according to their ability to be transparent to a particular wavelength or thermally conductive, depending on the application which it is desired that the mould should have. For example, the layers of a mould intended for lithography by nano-imprinting assisted by UV will be made of materials transparent to UV radiation.

Thus, the rigid materials which are transparent to UV radiation can, for example, be chosen from among silica, quartz and sapphire.

The rigid materials which are transparent to visible light can, for example, be chosen from among silica, quartz and sapphire.

It happens that silica, quartz and sapphire are rigid materials which are transparent both to visible light and to UV radiation. They can therefore be used equally for visible light and for UV radiation. It is, however, perfectly possible to choose rigid materials which are only transparent to UV radiation or to visible light.

The flexible materials which are transparent to UV radiation can, for example, be chosen from among silicones, polycarbonates, polyethylene and organic materials which are transparent to UV radiation.

The flexible materials which are transparent to visible light can, for example, be chosen from among silicones, polycarbonates, polyethylene and organic materials which are transparent to visible light.

As with the previous observation, it happens that silicones, polycarbonates, polyethylene and organic materials are flexible materials which are transparent both to visible light and to UV radiation, and can therefore be used equally for visible light and for UV radiation, but it is perfectly possible to use flexible materials which are transparent only to visible light or to UV radiation.

The rigid and thermally conductive materials can, for their part, be chosen, for example, from among silicon, silicon nitrides, carbides and metals.

The flexible and thermally conductive materials can, for example, be chosen from among silicones and polycarbonates.

We shall now describe an embodiment of a mould according to the invention. In particular, we shall manufacture a mould which is completely transparent to UV radiation, including a layer of rigid material, the entire surface of which includes patterns of micrometric and/or nanometric size, a layer of flexible material and a support.

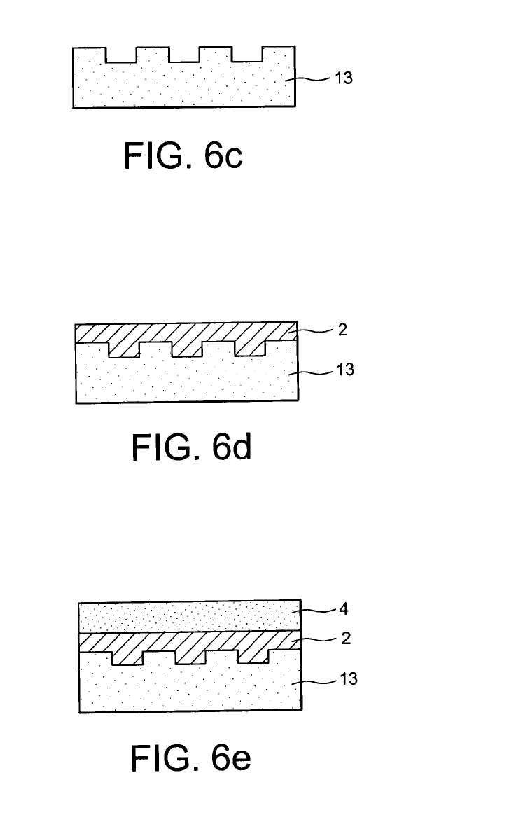

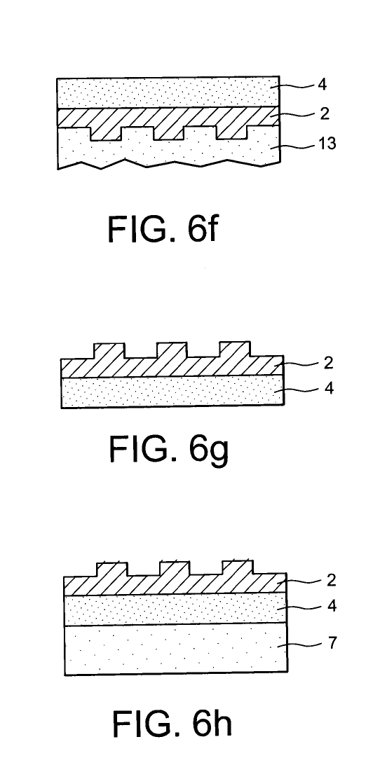

A structuring of the front face of an initial substrate 13 is firstly accomplished, for example by lithography (electronic, optical EUV or X lithography, lithography by FIB, etc.) and by etching (reactive ionic dry etching, ionic machining, wet etching, etc.). To do so, a layer of resin 14 is deposited on a face of a substrate of silicon or any other material habitually used in methods of micro- and nano-manufacture which are fully understood for the manufacture of microelectronic components (FIG. 6a), this resin layer is exposed according to a pattern representing the reverse image (negative imprint) of the pattern which it is desired to obtain on the face of the mould (FIG. 6b), and exposed resin layer 14 and the portions not covered by the resin are etched (FIG. 6c). For example, if it is desired to obtain n raised zones on the future mould, these n zones are etched recessed on the initial substrate. In our example, the choice has been made to use a silicon substrate since silicon enables etches to be made with resolutions of less than 10 nm and aspect ratios (height/width) of greater than 10.

A layer of a rigid material 2 which is transparent to UV radiation is then deposited on a structured face of the substrate, for example a layer of silicon oxide (FIG. 6d). The thickness of deposited layer 2 must be greater than the height of the patterns made in initial substrate 13. Secondly, the deposition must be accomplished in such a way that it properly fills the relief of the initial substrate.

After this, a layer of a flexible material 4 which is transparent to UV radiation is deposited on the layer of silicon oxide 2 (FIG. 6e). The deposited layer is made of PDMS, for example. The advantage of PDMS is that its Young's modulus can be adjusted according to the proportion of the rate of initiator contained in the PDMS preparation.

Most of initial substrate 13 is then removed by polishing or etching of its rear face (FIG. 6f). The remainder of the initial substrate is then removed by wet etching, for example by TMAH or KOH etching, in order to etch selectively the initial silicon substrate relative to the silicon oxide layer. It is judicious to choose a pair of materials for the initial substrate and the layer of rigid material which can be etched selectively.

A mould is then obtained including a layer 2 of rigid material which is transparent to UV radiation, and which is micro- or nano-structured (a layer of silicon oxide having a Young's modulus of several GPa), supported by a layer 4 of flexible material which is transparent to UV radiation (a layer of PDMS having a Young's modulus of between several kPa and several MPa) (FIG. 6g).

The layer of flexible material 4 may possibly be deposited on a support 7 of rigid material transparent to UV radiation (for example a substrate), in order to reduce the brittleness of the mould and to improve its mechanical strength (FIG. 6h).

The above example describes the formation of a mould having a single structured face, but it is possible to produce a mould having two structured faces. To do so, it is for example possible to make, firstly, a first stack by accomplishing steps 6a to 6g described above and, secondly, a second stack, by accomplishing steps 6a to 6g, and to bond the first stack to the second stack by their respective flexible layers.

In the example embodiment as represented in FIG. 6g or 6h, layer of rigid material 2 is structured according to a single zone occupying its entire surface. However, it is perfectly possible for the patterns to be confined to one or more isolated zones. In addition, when the layer of rigid material includes one or more confined structured zones, the mould may also include another layer of rigid material (called an intervening layer) on the layer of rigid material having the patterns. In this case, the intervening layer of rigid material (which may be transparent to UV radiation in this example) includes a number of cavities equal to the number of structured zones present in the layer of rigid material. In the example represented in FIGS. 6a to 6h, the intervening layer will be deposited on silicon oxide layer 2 in step 6d. The intervening layer is structured with cavities and a layer of flexible material is deposited on the intervening layer. Steps 6f to 6h are then accomplished. The intervening layer and the layer of rigid material may be made of the same material. The intervening layer and the layer of rigid material may also be a single, identical layer structured on its front face and its rear face. Another example embodiment of a mould including an intervening layer is described in detail above.

According to another example embodiment, a mould is manufactured including a layer of rigid material having thinned zones filled with a layer of flexible material.

A face of a substrate 15 is firstly structured. For example, substrate 15 is an SOI substrate consisting of a stack of a silicon layer 16, a buried layer of silicon oxide 17 and a silicon layer 18.

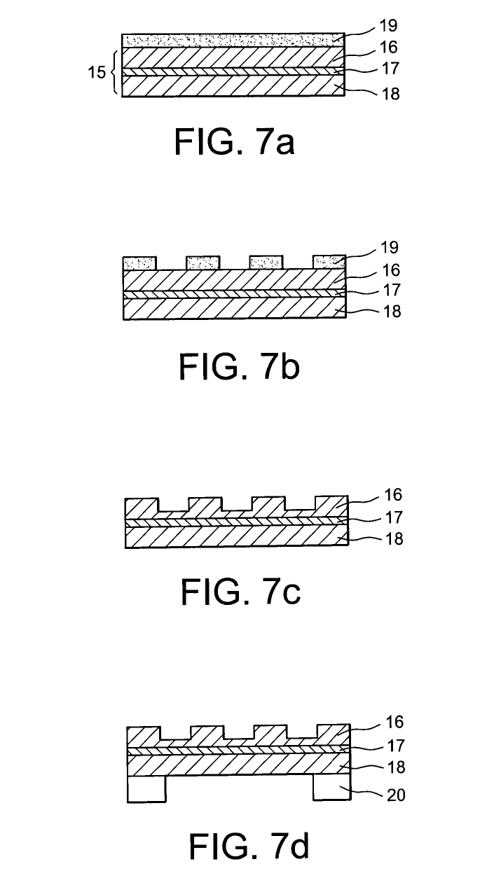

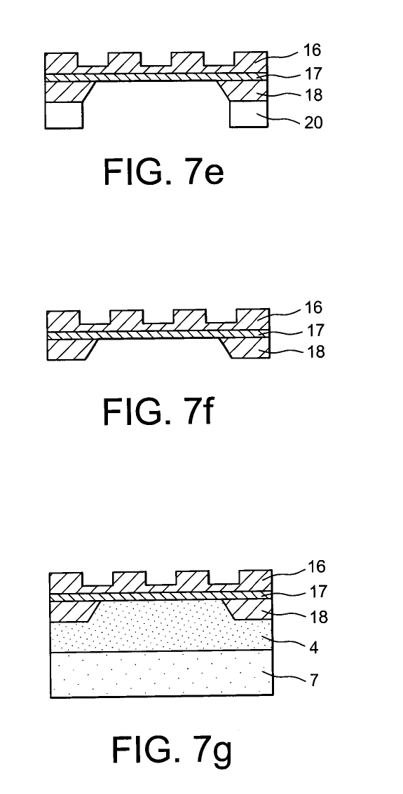

Structuring is accomplished by depositing a layer of photosensitive resin 19 on the front face of the substrate (FIG. 7a), by exposing the layer of resin according to a pattern representing the n structured zones which it is desired to obtain (FIG. 7b) and by etching the exposed resin layer and the portions not covered by the resin (FIG. 7c). The depth of the etched patterns can be less than or equal to the thickness of silicon layer 16 of the SOI substrate. If it is equal to the thickness of silicon layer 16, layer of silicon oxide 17 of the SOI substrate then acts as the stop layer of the etching.

The rear face of the substrate is then structured such that a cavity on the rear face of the substrate is facing each structured zone on the front face of the substrate. The cavity or cavities can be obtained by depositing a resin layer 20 on the rear face of the substrate (FIG. 7d), exposing the resin layer according to a pattern representing the cavity or cavities which it is sought to obtain, and then etching the exposed resin and the portions not covered by the resin (FIG. 7e). The etching can possibly be accomplished until the silicon oxide layer is reached, which then acts as an etching stop layer. It is then certain that the etching in the rear face of the substrate will not emerge in the front face in the patterns of the n structured zones.

A layer of flexible material 4, made for example of silicone or of polydimethylsiloxane (PDMS), is then deposited on the rear face of the substrate so as to cover the relief formed by the cavity or cavities (FIG. 7f).

Creation of the n cavities in the rear face of the substrate enables flexible material 4 to be deposited as close as possible to the structured zones present on the front face of the substrate.

The mechanical properties of the mould may possibly be improved by depositing the layer of flexible material of the mould on a support 7 of rigid material (FIG. 7g).

The mould obtained in this manner includes a layer of rigid material having different thicknesses, which enables the mechanical properties of the mould to be adjusted simply. By reducing the thickness of the layer of rigid material over the zones including the patterns, and by filling the space created in this manner with a flexible material, it is indeed possible to make the force applied to the mould in the area of the patterns uniform, and to reach more rapidly the final and uniform pressing state.

In the above examples we have described different variants, but other variants are also possible. In relation thereto, it should be noted that layers 16, 17 and 18 can be made of a single, identical material (for example, all three layers can be made of silicon); layers 16 and 18 can be of a given material, different to the material of layer 17 (for example, layers 16 and 18 can be of silicon, whereas layer 17 is of silicon oxide); layers 16 and 17 can be made of a single material, different from the material of layer 18 (for example, layers 16 and 17 can be made of silicon oxide, whereas layer 18 is made of silicon); layers 17 and 18 can be of a single material, different from the material of layer 16 (for example, layers 17 and 18 can be made of silicon, whereas layer 16 is made of silicon oxide or of silicon nitride SiₓN_{y}); layers 16, 17 and 18 can also all be of different materials (for example, layer 16 can be made of silicon nitride SiₓN_{y}, layer 17 can be made of silicon oxide and layer 18 can be made of silicon).

### BIBLIOGRAPHY

[1] Schmid H, Michel B., “Siloxane polymers for high-resolution, high-accuracy soft lithography”, Macromolecules, 33, p 3042-3049 (2000).

1. A mould for lithography, comprising a first layer, a second layer, an intervening layer, and a first structured face comprising n structured zone(s) having patterns of micrometric or nanometric size, wherein:
n is an integer greater than or equal to 1;
the first layer comprises the first structured face, and is supported by the second layer;
the first layer is made of a rigid material, and the second layer is made of a flexible material;
the intervening layer is situated between the first layer and the second layer, and is made of a rigid material; and
a face of the intervening layer which is opposite the first layer is structured with n cavities positioned opposite the n structured zones of the first layer, and is covered by the second layer such that the n cavities are filled by the flexible material.

2. The mould of claim 1, comprising p intervening layers situated between the first layer and the second layer,
wherein:
p is an integer greater than or equal to 1;
a Young's modulus of the second layer is lower than a Young's modulus of a p^{th} intervening layer situated adjacent to the second layer; and
if p is greater than 1, a Young's modulus of an (i)^{th} intervening layer is greater than a Young's modulus of the (i+1)^{th} intervening layer, where i=1 to (p−1).

3. The mould of claim 1, wherein the second layer is supported by a support made of rigid material.

4. The mould of claim 1, further comprising a third layer and a second structured face comprising m structured zone(s) having patterns of micrometric or nanometric size,
wherein:
m is an integer greater than or equal to 1;
the third layer comprises the second structured face, and is made of a rigid material; and
the first structured face and the second (9) structured face are positioned on either side of the second layer.

5. (canceled)

6. The mould of claim 1, wherein the first layer, the second layer, and the intervening layer are made of materials which are transparent to a wavelength λ in the range of UV or visible light wavelengths.

7. The mould of claim 3, wherein:
the support is made of quartz or silica;
the first layer is made of silica; and
the second layer is made of polydimethylsiloxane (PDMS) or silicone.

8. The mould of claim 1, wherein the first layer, the second layer and the intervening layer are made of thermally conductive materials.

9. A method for manufacturing a mould for lithography, the method comprising:
(i) structuring a front face so as to obtain n structured zones having patterns of micrometric or nanometric size, said front face being a face of a substrate made of a rigid material;
(ii) structuring a rear face of the substrate so as to obtain n cavities positioned opposite the n structured zones of the front face; and
(iii) depositing a layer of a flexible material on the rear face.

10. The method of claim 9, wherein the substrate comprises a stack of layers comprising, in order:
a layer of a first material;
a layer of a second material; and
a layer of a third material,
wherein:
the first material and the third material are made of rigid materials; and
the layer of the second material acts as a stop layer for the structuring (i), the structuring (ii), or both.

11. The method of claim 9, further comprising, between the structuring (ii) and the depositing (iii):
(iv) depositing p intervening layers on the rear face of the substrate,
wherein:
p is an integer greater than or equal to 1;
a Young's modulus of a p^{th} intervening layer, situated adjacent to the layer of flexible material, is greater than a Young's modulus of the layer of flexible material; and
if p is greater than 1, a Young's modulus of an (i)^{th} intervening layer is greater than a Young's modulus of an (i+1)^{th} intervening layer, where i=1 to (p−1).

12. The method of claim 10 or 11, further comprising, after the depositing (iii):
(v) depositing a support made of a rigid material on the layer of flexible material.

13. The method of claim 9, wherein in all layers constituting the mould, together with a support made of a rigid material, if present, are made of at least one selected from the group consisting of a material transparent to a wavelength λ in the range of UV wavelengths, a material transparent to a wavelength in the range of wavelengths of visible light, and
a thermally conductive material.

14-19. (canceled)

20. The mould of claim 2, wherein the first layer, the second layer, and the p intervening layers are made of materials which are transparent to a wavelength λ, in the range of UV or visible light wavelengths.

21. The mould of claim 3, wherein the first layer, the second layer, the intervening layer, and the support are made of materials which are transparent to a wavelength λ in the range of UV or visible light wavelengths.

22. The mould of claim 2, wherein the first layer, the second layer and the p intervening layers are made of thermally conductive materials.

23. The mould of claim 3, wherein the first layer, the second layer, the intervening layer, and the support are made of thermally conductive materials.

24. The mould of claim 2, wherein the second layer is supported by a support made of rigid material.
